(19) United States
(12) Patent Application Publication
(10) Pub. No.: US 2012/0317992 A1
(43) Pub. Date: Dec. 20, 2012

(54) FEED INJECTOR FOR GASIFICATION SYSTEM

(75) Inventors: Tony Ryu, Houston, TX (US); Edward Pan, Houston, TX (US); Prashant Marikatti, Bangalore (IN); Niraj Mishra, Bangalore (IN)

(73) Assignee: GENERAL ELECTRIC COMPANY, Schnectady, NY (US)

(21) Appl. No.: 13/162,623

(22) Filed: Jun. 17, 2011

(51) Int. Cl. F02C 6/04

(52) U.S. Cl. 60/784

(57) ABSTRACT

The present application and the resultant patent provide a feed injector nozzle for a gasification system with a reaction zone therein. The feed injector nozzle may include a number of tubes extending towards the reaction zone. The tubes may define a number of passages therebetween. A cooling water channel may extend through one of the tubes. The cooling water channel may include a first side adjacent to one of the passages and a second side adjacent to the reaction zone. The first side may include a first side thickness and the second side may include a second side thickness with the first side thickness being less than or equal to the second side thickness.

### TECHNICAL FIELD

The present application and the resultant patent relate generally to combined cycle power systems and more specifically relates to an improved cooling water channel for a feed injector of a gasification system that may avoid localized strain and associated cracking.

### BACKGROUND OF THE INVENTION

Combined cycle power systems generally include a gasification system that is integrated with a gas turbine engine. Known gasification systems convert a mixture of fuel, air/oxygen, steam, and/or other materials into an output of a partially oxidized gas known as a “syngas.” Known gasification systems generally use a teed injector to supply a mixture stream into a reactor vessel. Known feed injectors may be exposed to temperature extremes within the reactor vessels. Specifically, the tips of the feed injectors may be exposed to reaction temperatures that may inhibit effective operation of the injectors and/or shorten the life span thereof. Further, the feed injectors generally may be exposed to corrosive elements in the syngas flowing within the reactor vessel.

In order to protect the feed injectors, known gasification systems may use a closed loop water supply system to provide cooling water to the feed injector. Providing cooling water to the known feed injectors, however, may produce areas of localized strain and associated cracking. Specifically, the metal temperatures between an internal oxygen passage and an internal cooling water channel about the tip area may be relatively low as compared to the metal temperatures of the outside face about the combustion zone. Such temperature differences may be a multiple of about ten (10) times or so. The stiffness of the metal on the hot side thus decreases as the temperature increases. The hot side therefore may elongate more than the cool side and result in an area of high plastic strain therebetween. This area of high plastic strain may result in cracking or other damage therein. The time and effort required to repair such damage may be considerable.

There is thus a desire for an improved feed injector design for a gasification system. Such an improved feed injector design may reduce areas of plastic strain therein so as to reduce cracking and other types of damage. Reduced cracking may in turn provide reduced overall system downtime, repair costs, and increased component lifetime.

### SUMMARY OF THE INVENTION

The present application and the resultant patent thus provide a feed injector nozzle for a gasification system with a reaction zone therein. The feed injector nozzle may include a number of tubes extending towards the reaction zone. The tubes may define a number of passages therebetween. A cooling water channel may extend through one of the tubes. The cooling water channel may include a first side adjacent to one of the passages and a second side adjacent to the reaction zone. The first side may include a first side thickness and the second side may include a second side thickness with the first side thickness being less than or equal to the second side thickness.

The present application and the resultant patent further provide a gasifier for a combined cycle power system. The gasifier may include a vessel body, a reaction zone within the vessel body, and a feed injector extending into the vessel body about the reaction zone. The feed injector may include a nozzle tip with a cooling water channel therein. The cooling water channel may include a first side and a second side adjacent to the reaction zone. The first side may include a first side thickness and the second side may include a second side thickness such that the first side thickness is less than or equal to the second side thickness.

The present application and the resultant patent further provide a feed injector nozzle for a gasification system with a reaction zone therein. The feed injector nozzle may include a number of tubes extending towards the reaction zone. The tubes may define a number of passages therebetween. A cooling water channel may extend through one of the tubes. The cooling water channel may include a cool side adjacent to an oxygen passage and a hot side adjacent to the reaction zone. The cool side may include a cool side thickness and the hot side may include a hot side thickness such that the cool side thickness is less than or equal to the hot side thickness.

These and other features and improvements of the present application and the resultant patent will become apparent to one of ordinary skill in the art upon review of the following detailed description when taken in conjunction with the several drawings and the appended claims.

### BRIEF DESCRIPTION OF DRAWINGS

FIG. 1 is a schematic view of a combined cycle power system and the components therein.

FIG. 2 is a schematic view of a gasifier with a feed injector and a reaction zone.

FIG. 3 is a side cross-sectional view of a tip of the feed injector with a cooling water channel.

FIG. 4 is a side cross-section view of the tip with the cooling water channel.

FIG. 5 is a side cross-sectional view of a tip with a cooling water channel as may be described herein.

### DETAILED DESCRIPTION

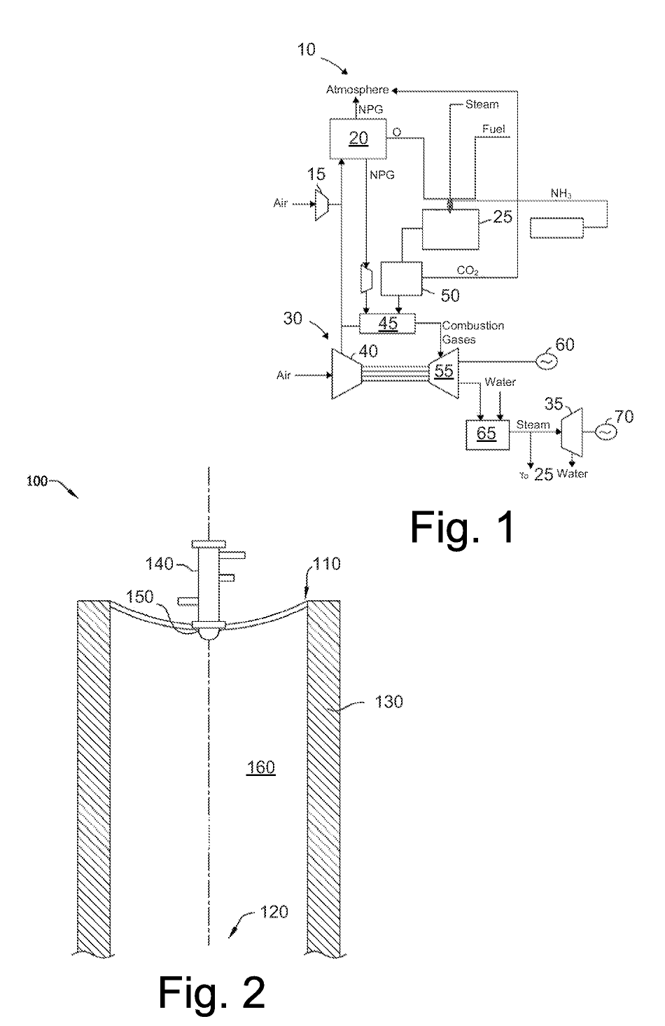

Referring now to the drawings in which like numerals refer to like elements throughout the several views, FIG. 1 shows a combined cycle power system 10. The combined cycle power system 10 may include a main air compressor 15, an air separation unit 20 coupled in flow communication with the compressor 15, a gasifier 25 coupled in flow communication with the air separation unit 20, a gas turbine engine 30 coupled in flow communication with the gasifier 25, and a steam turbine 35. Other components and other configurations may be used herein.

The compressor 15 compresses an ambient air flow that is channeled to the air separation unit 20. Alternatively, a compressed flow of air from a compressor 40 of the gas turbine engine 30 also may be used. The air separation unit 20 uses the compressed air to generate oxygen for use by the gasifier 25. The oxygen flow is used in the gasifier 25 in generating the partially oxidized syngas. A flow of nitrogen process gas from the air separation unit 20 also may be forwarded to a combustor 45 of the gas turbine engine 30 for use in reducing emissions and the like.

Specifically, the gasifier 25 converts a mixture of fuel, oxygen, steam, and/or other materials into an output of syngas for use by the gas turbine engine 30. The syngas may flow to the combustor 45 via a cleanup device 50. The cleanup device 50 may separate carbon dioxide and the like therein. The syngas may be combusted in the combustor 45 so as to produce a stream of hot combustion gases. The hot combustion gases drive a turbine 55 so as to produce mechanical work. The mechanical work produced by the turbine 55 drives the compressor 40 and an external load such as an electrical generator 60 and the like. The exhaust gases from the turbine 55 also may be channeled to a heat recovery steam generator 65. The heat recovery steam generator 65 generates steam for driving the steam turbine 35. The steam turbine 35 may drive a further load 70. A further supply of steam may be sent by the heat recovery steam generator 65 to the gasifier 25 so as to facilitate cooling of the syngas. Other components and other configurations may be used herein.

FIG. 2 is a schematic view of a solids removal gasifier 100 as may be described herein. The gasifier 100 may be used with the combined cycle power system 10 described above and the like. The gasifier 100 may include an head end portion 110, a tail end portion 120, and a substantially cylindrical vessel body 130 extending therebetween. A feed injector 140 penetrates the head end portion 110 to enable a flow of fuel to be channeled therein. Specifically, the flow of fuel through the feed injector 140 may be routed through a nozzle 150 thereof. The flow of fuel may discharge into a reaction zone 160. The reaction zone 160 may be a vertically oriented, generally cylindrical space that is substantially co-aligned with the nozzle 150. Syngas and byproducts may be generated within the reaction zone 160. Other components and other configurations may be used herein.

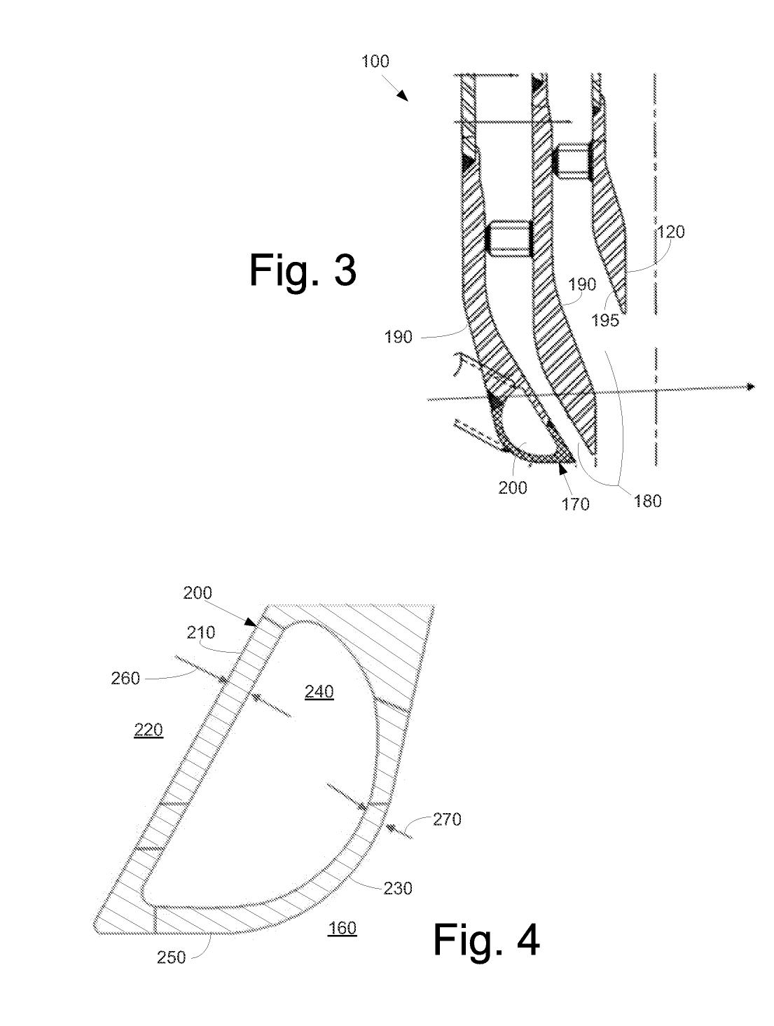

FIG. 3 shows a tip 170 of the nozzle 150 of the feed injector 140. The tip 170 may include several passages 180 defined therein for the flow of fuel oxygen, fuel, and the like. The size, shape, number, and configuration of these passages 180 may vary. The passages 180 may be defined by a number of concentrically arranged annular tubes 190. The tubes 190 may have a largely bayonet-like shape 195. One or more of the tubes 190 may include a cooling water channel 200 extending therein. The size, shape, number, and configuration of the cooling water channels 200 may vary. Other components and other configurations may be used herein.

FIG. 4 shows a close up view of a known cooling water channel 200. The cooling water channel 200 may include a cool side 210 that may be adjacent to an oxygen passage 220. The cooling water channel 200 also may include a hot side 230 that may be adjacent to the reaction zone 160. A flow of cooling water 240 flows therein. An area of maximum strain 250 may be positioned between the cool side 210 and the hot side 230. As described above, the area of maximum strain 250 may be prone to cracking and the like. The size and extent of the area of maximum strain 250 may vary.

The cool side 210 may have a cross-sectional thickness 260 that may be equal to or greater than a hot side thickness 270. Because the hot side 230 faces temperatures much higher than the cool side 210 by a multiple, the stiffness of the cool side 210 thus may be much greater than the stiffness of the hot side 230. The hot side 230 therefore may elongate to a degree greater than the cool side 210 so as to create the area of maximum strain 250.

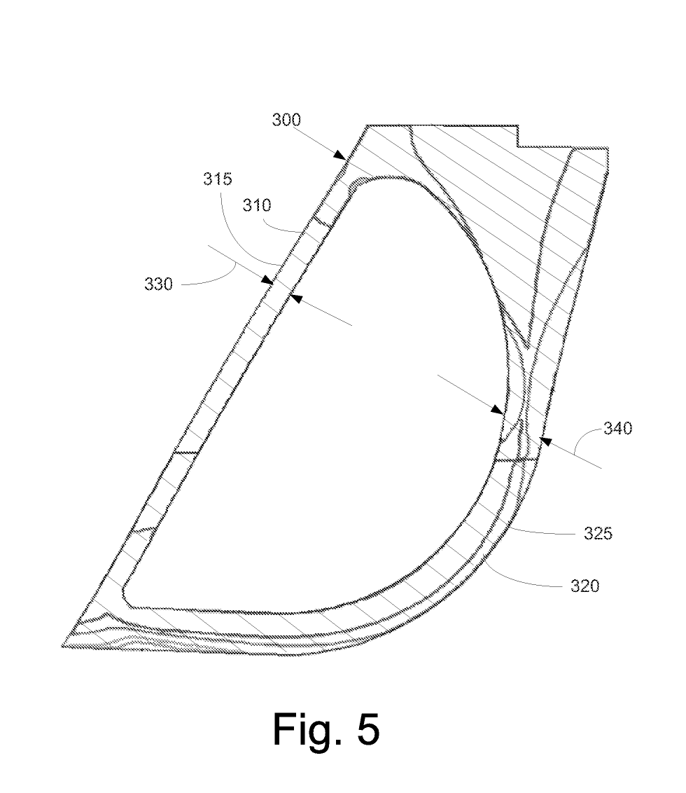

FIG. 5 shows a cooling water channel 300 as may be described herein. The cooling water channel 300 also may include a first side 310 that may be a cool side 315 and a second side 320 that may be a hot side 325. In this example, however, the cool side 315 may have a first side thickness 330 that is less than a second side thickness 340 of the hot side 325. By reducing the first side thickness 330, the stiffness of the cool side 315 also may be reduced. The stiffness of the cool side 315 thus may be closer to the stiffness of the hot side 325. Areas of similar stiffness therefore may serve to eliminate or reduce the areas of maximum strain 250. Reducing the areas of maximum strain should result in low cycle fatigue therein so as to increase the service life of the overall feed injector 140. Other components and other configurations may be used herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A feed injector nozzle for a gasification system with a reaction zone therein, comprising:
a plurality of tubes extending towards the reaction zone;
the plurality of tubes defining a plurality of passages therebetween; and
a cooling water channel extending through one of the plurality of tubes;
the cooling water channel comprising a first side adjacent to one of the plurality of passages and a second side adjacent to the reaction zone;
wherein the first side comprises a first side thickness and the second side comprises a second side thickness and wherein the first side thickness is less than or equal to the second side thickness.

2. The feed injector nozzle of claim 1, wherein the first side comprises a cool side.

3. The feed injector nozzle of claim 1, wherein the second side comprises a hot side.

4. The feed injector nozzle of claim 1, wherein the plurality of tubes extends towards the reaction zone about a tip of the feed injector nozzle.

5. The feed injector nozzle of claim 1, wherein the one of the plurality of passages comprises an oxygen passage.

6. The feed injector nozzle of claim 1, wherein the cooling water channel comprises a flow of cooling water therein.

7. The feed injector of claim 1, wherein the plurality of tubes comprises a bayonet-like shape.

8. The feed injector nozzle of claim 1, wherein the first side thickness minimizes an area of strain between the first side and the second side.

9. The feed injector nozzle of claim 1, wherein the first side comprises a first side temperature and the second side comprises a second side temperature and wherein the first side temperature is less than the second side temperature by a multiple.

10. A gasifier for a combined cycle power system, comprising:
a vessel body;
a reaction zone within the vessel body;
a feed injector extending into the vessel body about the reaction zone;
the feed injector comprising a nozzle tip with a cooling water channel therein;
the cooling water channel comprising a first side and a second side adjacent to the reaction zone;
wherein the first side comprises a first side thickness and the second side comprises a second side thickness and wherein the first side thickness is less than or equal to the second side thickness.

11. The gasifier of claim 10, wherein the nozzle tip comprises a plurality of tubes extending towards the reaction zone and defining a plurality of passages therebetween.

12. The gasifier of claim 11, wherein the cooling water channel extends through one of the plurality of tubes.

13. The gasifier of claim 11, wherein the first side extends along one of the plurality of passages.

14. The gasifier of claim 13, wherein the one of the plurality of passages comprises an oxygen passage.

15. The gasifier of claim 11, wherein the plurality of tubes comprises a bayonet-like shape.

16. The gasifier of claim 10, wherein the first side comprises a cool side.

17. The gasifier of claim 10, wherein the second side comprises a hot side.

18. The gasifier of claim 10, wherein the cooling water channel comprises a flow of cooling water therein.

19. The gasifier of claim 10, wherein the first side comprises a first side temperature and the second side comprises a second side temperature and wherein the first side temperature is less than the second side temperature by a multiple.

20. A feed injector nozzle for a gasification system with a reaction zone therein, comprising:
a plurality of tubes extending towards the reaction zone;
the plurality of tubes defining a plurality of passages therebetween; and
a cooling water channel extending through one of the tubes;
the cooling water channel comprising a cool side adjacent to an oxygen passage of the plurality of passages and a hot side adjacent to the reaction zone;
wherein the cool side comprises a cool side thickness and the hot side comprises a hot side thickness and wherein the cool side thickness is less than or equal to the hot side thickness.
